(19) United States
(12) Patent Application Publication
(10) Pub. No.: US 2018/0068232 A1
(43) Pub. Date: Mar. 8, 2018

(54) EXPERT-ASSISTED ONLINE-LEARNING FOR MEDIA SIMILARITY

(71) Applicant: TELEFONAKTIEBOLAGET LM ERICSSON (PUBL), Stockholm (SE)

(72) Inventors: Alvin Jude Hari Haran, Sunnyvale, CA (US); Julien Forgeat, San Jose, CA (US); Per-Erik Brodin, Los Gatos, CA (US)

(21) Appl. No.: 15/467,362

(22) Filed: Mar. 23, 2017

Related U.S. Application Data
(60) Provisional application No. 62/384,385, filed on Sep. 7, 2016.

(51) Int. Cl. G06N 99/00; G06F 17/30; G06F 3/0482

(52) U.S. Cl. CPC G06N 99/005; G06F 17/3097; G06F 3/0486; G06F 3/0482; G06F 17/3084

(57) ABSTRACT

A system (e.g., content management system), a recommender system, a storage device, and various methods are described herein that improves with the aid of human (expert) judgment the online-learning for item-item similarity (e.g., movie-movie similarity).

### CLAIM OF PRIORITY

This application claims the benefit of U.S. Provisional Application No. 62/384,385, filed Sep. 7, 2016. The disclosure of this document is hereby incorporated herein by reference for all purposes.

### RELATED PATENT APPLICATION

This application is related to co-assigned U.S. application Ser. No. ______ (Docket No. P50666US2), filed on ______, and entitled “System and Method for Recommending Semantically Similar Items”, which claims the benefit of U.S. Provisional Application No. 62/370,155, filed Aug. 2, 2016. The disclosure of this document is hereby incorporated herein by reference for all purposes.

### TECHNICAL FIELD

The present disclosure relates generally to a system (e.g., content management system), a recommender system, a storage device, and various methods that improves with the aid of human (expert) judgment the online-learning for item-item similarity (e.g., movie-movie similarity).

### BACKGROUND

The following abbreviations are herewith defined, at least some of which are referred to within the following description of the present disclosure.

### CMS Content Management System

### DVD Digital Video Disc

### GUI Graphical User Interface

### FN False Negative

### FP False Positive

### I-I CF Item-Item Collaborative Filtering

### SVM Support Vector Machine

### TF-IDF Term Frequency-Inverse Document Frequency

### TN True Negative

### TP True Positive

### TV Television

### UI User Interface

### U-U CF User-User Collaborative Filtering

### VoD Video on Demand

Current online services such as Netflix, Google Play, and Amazon present a user with many choices for consuming media. However, when there are too many items to choose from, users generally choose none. There are various terms used for this problem including data deluge, content chaos, information overload, and the paradox of choice. It is generally accepted that a good recommender system will help mitigate this problem by limiting items presented to the consumer to ones that are most relevant. An example of this can be seen in Netflix, Google Play, and Amazon. Recommender systems generally do two things: recommending items to users, and suggesting similar items to one that is chosen. The present disclosure is concerned with the latter, and more specifically suggesting similar items to one that is chosen in the domain of media items such as movies and TV series, including documentaries, news and magazines.

Referring to FIG. 1 (PRIOR ART), there is illustrated a contrived example of a graphical user interface (GUI) 100 from a Video-on-Demand (VoD) service that depicts how similar items could be recommended to the consumer, where the GUI 100 was inspired by Google Play Movies and TV [https://play.google.com/store/movies]. When a user selects a movie (in this case the movie Big Buck Bunny from 2008), movies that the recommender system judges to be similar are shown below the title (in this case the movies Elephants Dream, Murnau the Vampire, and Tears of Steel).

As discussed next, similar items could be evaluated and selected in either one of three ways, two of which are algorithmic.

### Manual Curation

A human operator (e.g., an employee of a broadcaster or VoD service provider who is trained in the art) could manually select and add a list of similar movies to each movie. This will need to be done for each movie added to the library. The human operator can optionally set similarity to be symmetrical (i.e., if A˜B then B˜A), so that when a new movie B is added to the library and it is decided that B is similar to A, then A will also have knowledge that B is similar.

### Algorithmic: Item-Item Collaborative Filtering (I-I CF)

Collaborative filtering is a broad category of algorithms that utilizes information of the users who consume the items. It was first used to identify similar users, to then supply personalized recommendations. For example if user U1 enjoys movies {M1, M2, and M3}, and user U2 enjoys movies {M1, M2, M3 and M4}, the algorithm can infer that user U1 is similar to user U2, and user U1 will therefore also enjoy movie M4. This concept is one of the most widely used methods of generating personalized recommendations in academia and in practice, and is generally referred to as user-user collaborative filtering (U-U CF). An extension of collaborative filtering was later introduced referred to as item-item collaborative filtering (I-I CF). Here, the I-I CF algorithms turn the measure of similarity on items instead of users. E.g.: if Movie M1 and M2 are both liked by users {U1, U2, U3 and U4} but disliked by users {U8, U9}, then the I-I CF algorithms can consider these two movies to be similar.

I-I CF has shown to be better than U-U CF in terms of speed of operation. In addition, these calculations can be done offline and cached for longer periods of times, which is favorable in large libraries. I-I CF is generally used to provide recommendations to users similar to U-U CF but it has also been used to identify similar movies as per FIG. 1 (PRIOR ART).

### Algorithmic: Content Filtering

Content-based filtering uses the “content” of an item to infer similarity. Content as it applies to movies in this context refer to metadata, such as genre, cast, credits, language, ratings, and so on. It is therefore also referred to as “semantic similarity”, as similarity is judged based on semantic similarity rather than inferred based on user consumption. The most common way to calculate semantic similarity of two items would be to weigh each metadata and then calculate an aggregated sum. For example, the similarity between two movies A and B can be calculated as follows:

Sim(A,B)=(Weight(Genre)*Sim(Genre(A,B))+(Weight(Cast)*Sim(Cast(A,B))[ . . . ] (eq. 1)

In the above equation, the similarity between the two items A and B are calculated as the similarity between the genres of A and B, added to the similarity of the cast, added to the similarity of the any other metadata. Each similarity is also weighted accordingly. A common algorithm that could be used here is referred to as Term Frequency Inverse Document Frequency (TF-IDF) and Bag-of-words [e.g., see Lucas Colucci et al. “Evaluating Item-Item Similarity Algorithms for Movies” (2016)—the contents of which are incorporated herein by reference for all purposes].

The following is a discussion about problems with these existing solutions.

### High Effort and Mental Load if Done Manually

The manual curation approach is possible but highly infeasible given the number of options to choose from. The MovieLens open database (http://movieLens.org) has about 27,000 movies. IMDb has approximately 2 million movies and TV series, which may not include many local non-english productions. Hence, manual curation will be extremely difficult, if not completely impossible.

### Algorithms are not Good Enough

The main problem that the Applicant sees with the existing algorithmic solutions is that they are usually done without a human expert to provide judgment. The problem manifests itself in the results presented to the users. When users select an item on a store such as Google Play Movies, they are shown a list of similar movies, but these movies may not be perceived to be similar to users (generally because they are not). Two specifically-picked examples are discussed next with respect to FIGS. 2 and 3 (PRIOR ART) where these algorithmic methods fail.

Referring to FIG. 2 (PRIOR ART), there is illustrated a GUI 200 obtained from Google Play Movies where Titanic (1997), screencap from August 2015 is shown. The algorithm has picked various Marvel movies and Ninja Turtles as similar movies. While it can be argued that similarity is a matter of individual perception, it is hard to explain how any of the aforementioned movies are similar to an almost-classic romantic tragedy.

Referring to FIG. 3 (PRIOR ART), there is illustrated a GUI 300 obtained from Google Play Movies where Gravity (2013), screencap from August 2015 is shown. We see a similar problem here, where a science-fiction movie has a list of movies that have nothing to do with it whatsoever.

While it is difficult to determine why the similar recommendations of FIGS. 2 and 3 (PRIOR ART) fail, we believe that it is due to the algorithms generally used. There are two main classes of algorithms used to identify similar movies: content-based and collaborative filtering, both of which have been described in the previous section. We discuss their drawbacks below.

Collaborative Filtering Problems

As pointed out before, the more relevant way to select similar movies are with I-I CF and not U-U CF. However, it should be noted that that I-I CF does not actually identify similar movies; it identifies movies that co-occur, or are correlated by virtue of sharing the same user base. As such there are providers that yield by rephrasing the list of “similar” movies to “Users who watched M1 also watched . . . ” followed by the list of movies provided by the algorithms. This linguistic manipulation acknowledges the problem, but does nothing to address it. Looking at examples in FIGS. 2 and 3 (PRIOR ART) with this knowledge, users might be able to understand that consumers who watched Titanic also watched Iron Man. But this knowledge is somewhat meaningless in context.

There are many known problems that exacerbate the above; we describe two of these problems next.

1. The Super-node problem: A “Super-node” is a node in a graph that has connections to a large amount of other nodes. Titanic is a good example of a supernode; it is one of the most watched movies in the world. Assuming the majority of people on a media platform have watched Titanic, it will have a large number of connections to users, making it a “super node”. Therefore, the fact that many people who watched Titanic also watched Iron Man is trivial, and meaningless. In fact, in this case, the list of similar movies isn't too different from the list of the most popular titles.

2. The Cold-start problem: Collaborative Filtering requires critical mass for it to work well. Specifically, we need a large amount of explicit input from users. The cold start problem affects new users (U-U CF), where they cannot get good recommendations without first submitting ratings. It also affects newly added movies (I-I CF and U-U CF), as it will not be recommended to users without first getting ratings from users. Likewise, the newly added movies will also not get many good similar movies recommendations unless there are ratings submitted. The cold start problem is especially prevalent in newly deployed systems where ratings or consumption behavior is not recorded. Since there are no ratings, there can be no recommendations whatsoever.

Content-Based Filtering Problems

This discussion follows from the above description related to content-based filtering algorithm (see equation no. 1). The first problem here is with the selection of features such as, for example, which features make two movies similar? Is it the cast? Genre? Director? The second problem is the assignment of weights such as, for example, which metadata should be weighted more than another? How much should that weight be set exactly? The most common usage in published academic literature considers genre, cast, and director in the similarity functions, occasionally with weights, sometimes without. However, this notion has not been validated in any way. Hence, there is no real idea if these are the right features to consider, plus it is not known if users perceive the outcome to be actually similar. The end result is a set of algorithms and/or models that is correct based on the perception of the engineers who built them. The algorithms are generally untested against the opinions of the users, nor are they tested against a critical mass of movies. In machine-learning terms, this notion of similarity is unsupervised. There is no ground truth or labels to train a model since there is no comprehensive list of movies that are similar to others.

### Obviousness and Diversity

Another potential problem with pure algorithmic evaluations of similarity is that it could produce a list of items that are too similar, to the point that they are obvious and not useful. For example, if a user discovers that the movie Lord of the Rings (LoTR) 2 is added to his catalog and peeks into the movie, and then looks for a list of similar movies, he could be shown LoTR 1, LoTR3, The Hobbit 1, The Hobbit 2, and The Hobbit 3. This list is not incorrect, but it's not exactly useful either. It could be interpreted as too similar and therefore is lacking diversity.

### Lack of Labelled Data

Machine learning can be done based on supervised learning or unsupervised learning. In the case of supervised learning, one tries to predict a label, while in the case of unsupervised learning one tries to cluster items together. For example, with supervised learning one could predict the price of a used car based on make, model, age and color. The label is the price, and based on historical data that correlates the features to the price to the rest of the features this can be used to train an algorithm. One could also train an algorithm to cluster cars based on their features, e.g.: make, model, age, color. When another used car is entered into the database, it can be assigned to the correct cluster based on that car's features.

Movie similarity is currently viewed as an unsupervised learning problem, where they are clustered together based on some features. But we can see that this is insufficient based simply on the observations in FIGS. 2 and 3 (PRIOR ART). In addition, in our previously published work Lucas Colucci et al. “Evaluating Item-Item Similarity Algorithms for Movies” (2016), we showed that current unsupervised techniques are perceived by users to be only about 50% correct. One approach, that was tried to improve this is was to ask people to label movies if they are similar or not, possibly in a crowd-sourced manner. This could allow one to collect labels, and therefore to translate the problem from an unsupervised learning problem into a supervised learning problem. However, no such system exists to the best of our knowledge. Even if it does, it will be subject to the wisdom of the crowd, and not experts. This will also not be a sustainable model, at least in the short term, as it is not yet known what actually makes users perceive movies to be similar.

The lack of labels is what we believe to be the biggest problem in identifying similar titles. It seems to be trivial that if we had such labels, it would be possible to train better algorithms. However, the concept of similarity is a matter of perception and knowledge to most people. Ideally what we would want is a set of labels curated by experts, with an indication of how similar item A is to item B. This need and other needs are satisfied by the present disclosure.

### SUMMARY

A system, a recommender system, a storage device, and various methods which address the aforementioned problem are described in the independent claims. Advantageous embodiments of the system, the recommender system, the storage device, and the various method are further described in the dependent claims.

In one aspect, the present disclosure provides a system (e.g., content management system) which comprises a recommender system, a first GUI (which is used by a human operator-expert), and a storage device. The first GUI is configured to transmit metadata of a media item to the recommender system. The recommender system is configured to use the metadata of the media item and a similarity model to find at least one of: (1) suggested similar items associated with the media item, and (2) suggested items from same series associated with the media item. The recommender system is further configured to send a first fetch command to the storage device to have the at least one of: (1) the suggested similar items associated with the media item, and (2) the suggested items from same series associated with the media item sent to the first GUI. The first GUI is configured to display the at least one of: (1) the suggested similar items associated with the media item, and (2) the suggested items from same series associated with the media item and further configured to enable an operator to correct the at least one of: (1) the suggested similar items associated with the media item, and (2) the suggested items from same series associated with the media item to provide at least one of: (1) corrected similar items associated with the media item, and (2) corrected items from same series associated with the media item. The first GUI is further configured to send the at least one of: (1) the corrected similar items associated with the media item, and (2) the corrected items from same series associated with the media item to the recommender system. The recommender system is configured to use the at least one of: (1) the corrected similar items associated with the media item, and (2) the corrected items from same series associated with the media item to update the similarity model with respect to the media item. The system has the following advantages (for example): (1) improves operator experience; (2) improves customer experience; (3) increases diversity between list of similar items and list of items in the same series with respect to a media item; and (4) allows on-line learning.

In one aspect, the present disclosure provides a recommender system which comprises a processor and a memory that stores processor-executable instructions, wherein the processor interfaces with the memory to execute the processor-executable instructions, whereby the recommender system is operable to perform a first receive operation, a first use operation, a send operation, a second receive operation, and a second use operation. In the first receive operation, the recommender system receives, from a first GUI, metadata associated with a media item. In the first use operation, the recommender system use the metadata of the media item and a similarity model to find at least one of: (1) suggested similar items associated with the media item, and (2) suggested items from same series associated with the media item. In the send operation, the recommender system sends, to a storage device, a first fetch command to have the at least one of: (1) the suggested similar items associated with the media item, and (2) the suggested items from same series associated with the media item sent to the first GUI to be corrected by an operator. In the second receive operation, the recommender system receives, from the first GUI, at least one of: (1) corrected similar items associated with the media item, and (2) corrected items from same series associated with the media item. In the second use operation, the recommender system uses the at least one of: (1) the corrected similar items associated with the media item, and (2) the corrected items from same series associated with the media item to update the similarity model with respect to the media item. The recommender system has the following advantages (for example): (1) improves operator experience; (2) improves customer experience; (3) increases diversity between list of similar items and list of items in the same series with respect to a media item; and (4) allows on-line learning.

In another aspect, the present disclosure provides a method in recommender device. The method comprises a first receiving step, a first using step, a sending step, a second receiving step, and a second using step. In the first receiving step, the recommender system receives, from a first GUI, metadata associated with a media item. In the first using step, the recommender system use the metadata of the media item and a similarity model to find at least one of: (1) suggested similar items associated with the media item, and (2) suggested items from same series associated with the media item. In the sending step, the recommender system sends, to a storage device, a first fetch command to have the at least one of: (1) the suggested similar items associated with the media item, and (2) the suggested items from same series associated with the media item sent to the first GUI to be corrected by an operator. In the second receiving step, the recommender system receives, from the first GUI, at least one of: (1) corrected similar items associated with the media item, and (2) corrected items from same series associated with the media item. In the second using step, the recommender system uses the at least one of: (1) the corrected similar items associated with the media item, and (2) the corrected items from same series associated with the media item to update the similarity model with respect to the media item. The method has the following advantages (for example): (1) improves operator experience; (2) improves customer experience; (3) increases diversity between list of similar items and list of items in the same series with respect to a media item; and (4) allows on-line learning.

In one aspect, the present disclosure provides a storage device which comprises a processor and a memory that stores processor-executable instructions, wherein the processor interfaces with the memory to execute the processor-executable instructions, whereby the storage device is operable to perform a first receive operation, a send operation, a second receive operation, and a store operation. In the first receive operation, the storage device receives, from a recommender system a first fetch command indicating at least one of: (1) a suggested similar items associated with a media item, and (2) a suggested items from same series associated with the media item. In the send operation, the storage device sends, to a first GUI, the at least one of: (1) the suggested similar items associated with the media item, and (2) the suggested items from same series associated with the media item to be corrected by an operator. In the second receive operation, the storage device receives, from the first GUI, at least one of: (1) corrected similar items associated with the media item, and (2) corrected items from same series associated with the media item. In the store operation, the storage device stores the at least one of: (1) the corrected similar items associated with the media item, and (2) the corrected items from same series associated with the media item. The storage device has the following advantages (for example): (1) improves operator experience; (2) improves customer experience; (3) increases diversity between list of similar items and list of items in the same series with respect to a media item; and (4) allows on-line learning.

In another aspect, the present disclosure provides a method in a storage device. The method comprises a first receiving step, a sending step, a second receiving step, and a storing step. In the first receiving step, the storage device receives, from a recommender system a first fetch command indicating at least one of: (1) a suggested similar items associated with a media item, and (2) a suggested items from same series associated with the media item. In the sending step, the storage device sends, to a first GUI, the at least one of: (1) the suggested similar items associated with the media item, and (2) the suggested items from same series associated with the media item to be corrected by an operator. In the second receiving step, the storage device receives, from the first GUI, at least one of: (1) corrected similar items associated with the media item, and (2) corrected items from same series associated with the media item. In the storing step, the storage device stores the at least one of: (1) the corrected similar items associated with the media item, and (2) the corrected items from same series associated with the media item. The method has the following advantages (for example): (1) improves operator experience; (2) improves customer experience; (3) increases diversity between list of similar items and list of items in the same series with respect to a media item; and (4) allows on-line learning.

Additional aspects of the present disclosure will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the present disclosure.

### BRIEF DESCRIPTION OF THE DRAWINGS

A more complete understanding of the present disclosure may be obtained by reference to the following detailed description when taken in conjunction with the accompanying drawings:

FIG. 1 (PRIOR ART) is a diagram of an exemplary graphical user interface (GUI) from a Video-on-Demand (VoD) service that depicts how similar items could be recommended to the consumer;

FIG. 2 (PRIOR ART) is a diagram of an exemplary GUI obtained from Google Play Movies where Titanic (1997), screencap from August 2015 is shown along with so-called similar items that were depicted to the consumer;

FIG. 3 (PRIOR ART) is a diagram of an exemplary GUI obtained from Google Play Movies where Gravity (2013), screencap from August 2015 is shown along with so-called similar items that were depicted to the consumer;

FIG. 4 is a basic diagram of an exemplary first GUI (which is an interface for a human operator/expert) that is configured in accordance with an embodiment of the present disclosure;

FIG. 5 is a sequence diagram illustrating the interactions between a recommender system, the first GUI (which is an interface for the human operator/expert) and a storage unit which are part of the system in accordance with an embodiment of the present disclosure;

FIG. 6 is a basic diagram of the first GUI used to illustrate how the operator can perform corrections or updates to the similar titles and titles in same series for a specific media item in accordance with an embodiment of the present disclosure;

FIG. 7 is a sequence diagram illustrating the interactions between the recommender system, the second GUI (which is an interface for the consumer) and the storage unit which are part of the system in accordance with an embodiment of the present disclosure;

FIG. 8A is an illustration of an exemplary second GUI that can be used by the consumer in accordance with an embodiment of the present disclosure;

FIG. 8B is an illustration of another exemplary second GUI that can be used by the consumer in accordance with an embodiment of the present disclosure;

FIG. 9 is a flowchart of a method implemented in the storage unit to enhance the “get similar items” per steps 7 and 12 of FIG. 7 in accordance with an embodiment of the present disclosure;

FIG. 10 is a flowchart of a method implemented in the recommender system in accordance with an embodiment of the present disclosure;

FIG. 11 is a block diagram illustrating an exemplary structure of the recommender system in accordance with an embodiment of the present disclosure;

FIG. 12 is a flowchart of a method implemented in the storage device in accordance with an embodiment of the present disclosure; and,

FIG. 13 is a block diagram illustrating an exemplary structure of the storage device in accordance with an embodiment of the present disclosure.

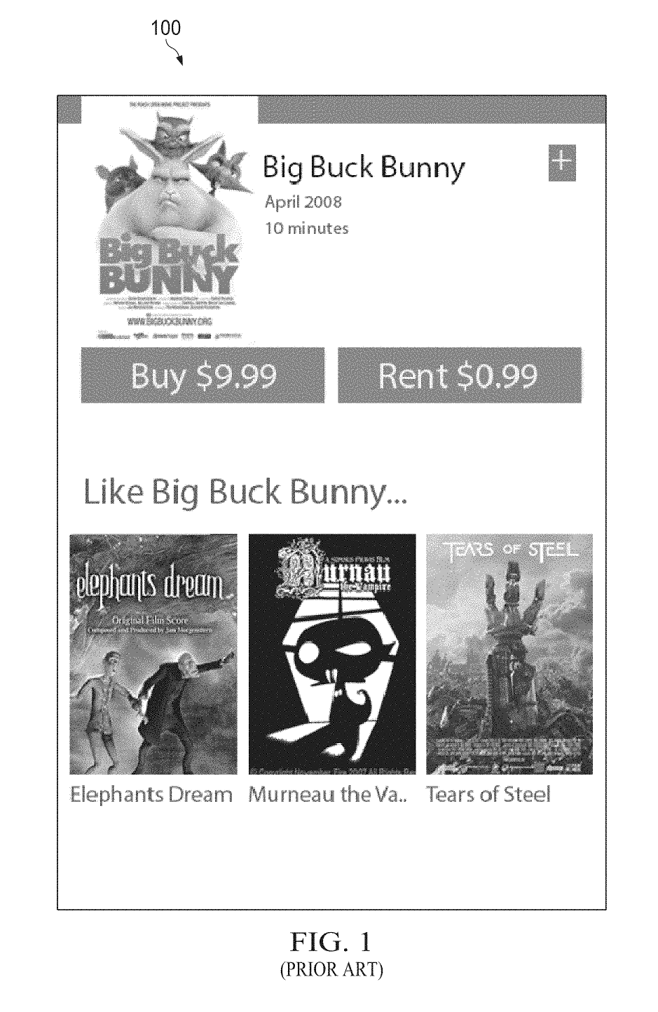

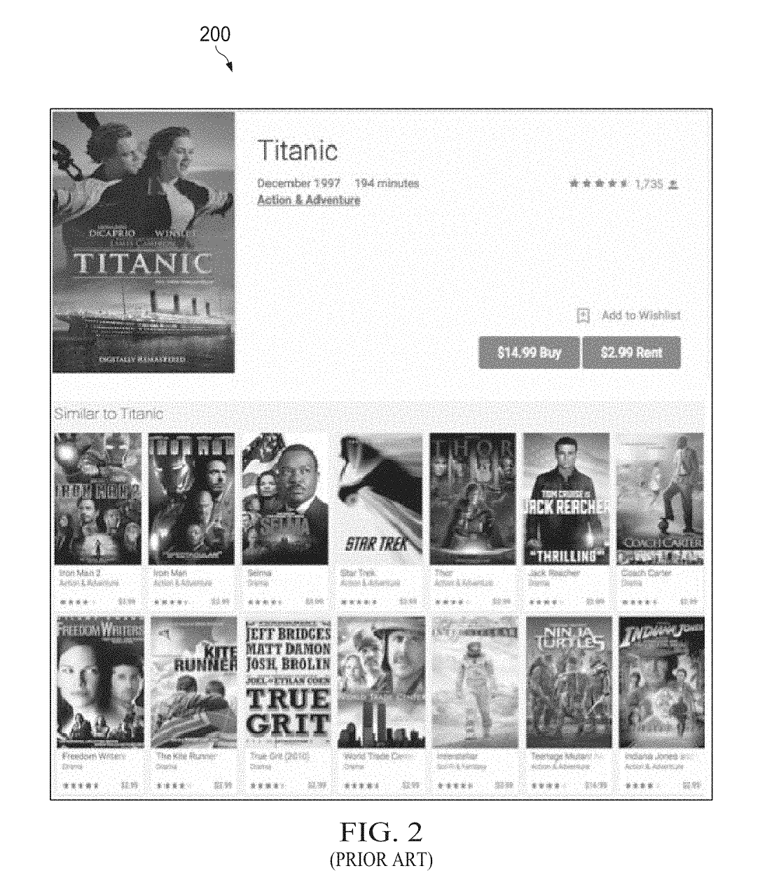

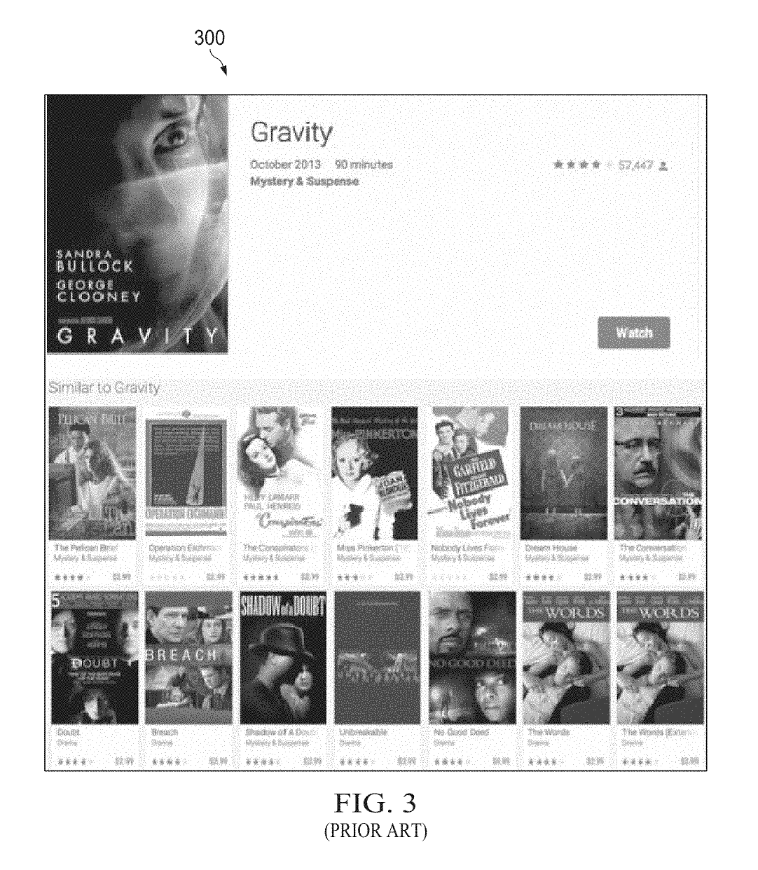

### DETAILED DESCRIPTION

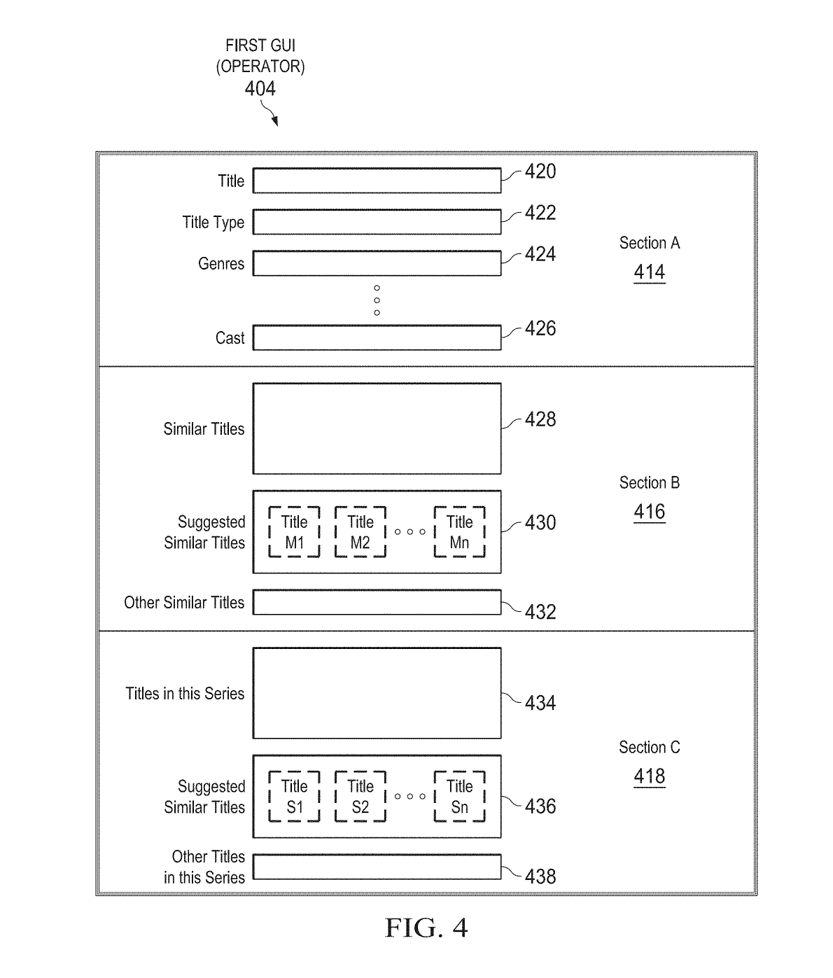

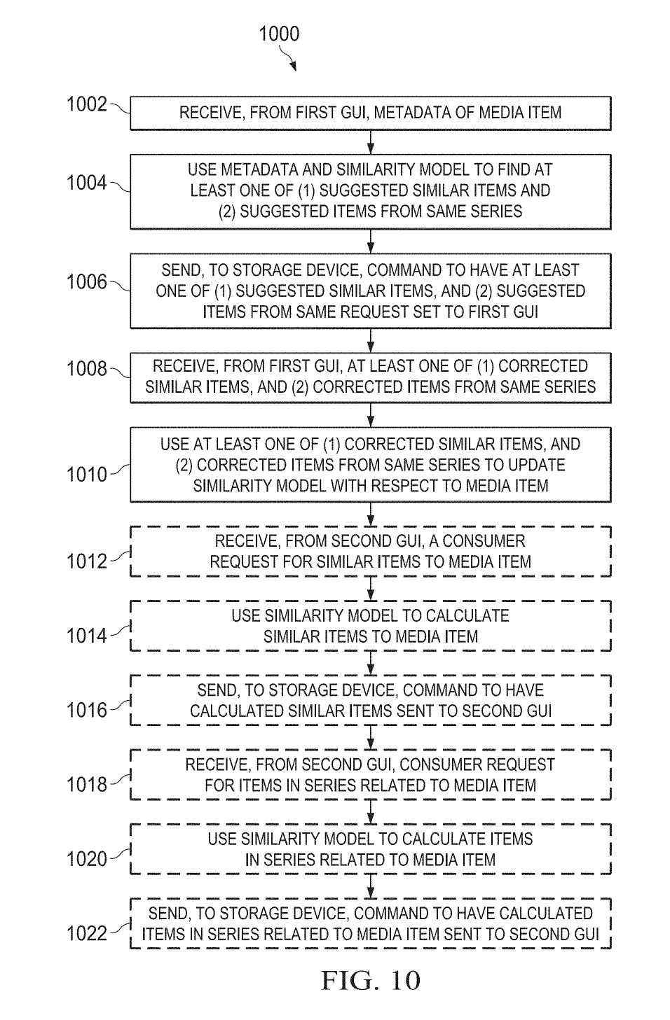

A discussion is provided first herein to describe a brief summary of a new media platform that includes a system (e.g., content management system) which predicts at least one of a “similar items” and a “items in this series” with respect to a specific item with the aid of human judgment in accordance with an embodiment of the present disclosure. Then, a discussion is provided to describe a more detailed way that the system can predict at least one of the “similar items” and the “items in this series” with respect to a specific item with the aid of human judgment in accordance with an embodiment of the present disclosure (see FIGS. 4-9). Thereafter, a discussion is provided to explain the basic functionalities-configurations of a recommender system and a storage device of the system in accordance with an embodiment of the present disclosure (see FIGS. 10-13).

### Brief Summary of New Media Platform

The new media platform solution includes a system (e.g., content management system) and in particular a recommender system that self-learns how to predict at least one of a “similar items” and a “items in this series” in view of a specific item (e.g., movie). These predictions are shown to the operator (e.g., expert) who can first decide if the items (e.g., movies) are indeed similar or not to the specific item (e.g., movie), and then rank the similar items by degree of similarity. The feedback from the operator is used to improve the algorithms implemented by the recommender system in an online fashion. Thus, the algorithms themselves will improve over time, while the consumers will only see a list of similar items (e.g., movies) that have been somewhat curated or at least human verified. The same applies for the list of “items in this series”, the recommender system will predict these items (e.g., movies) and the operator will decide if similar and rank the items. If desired, the recommender system can automatically sort all similar items (e.g., movies) by release date for simplicity. The operator may be allowed to change the ordering if they desire. The feedback will be used to improve the algorithm of the recommender system and the curated items (e.g., movies) will be shown to the consumers.

### Detailed Description of New Media Platform

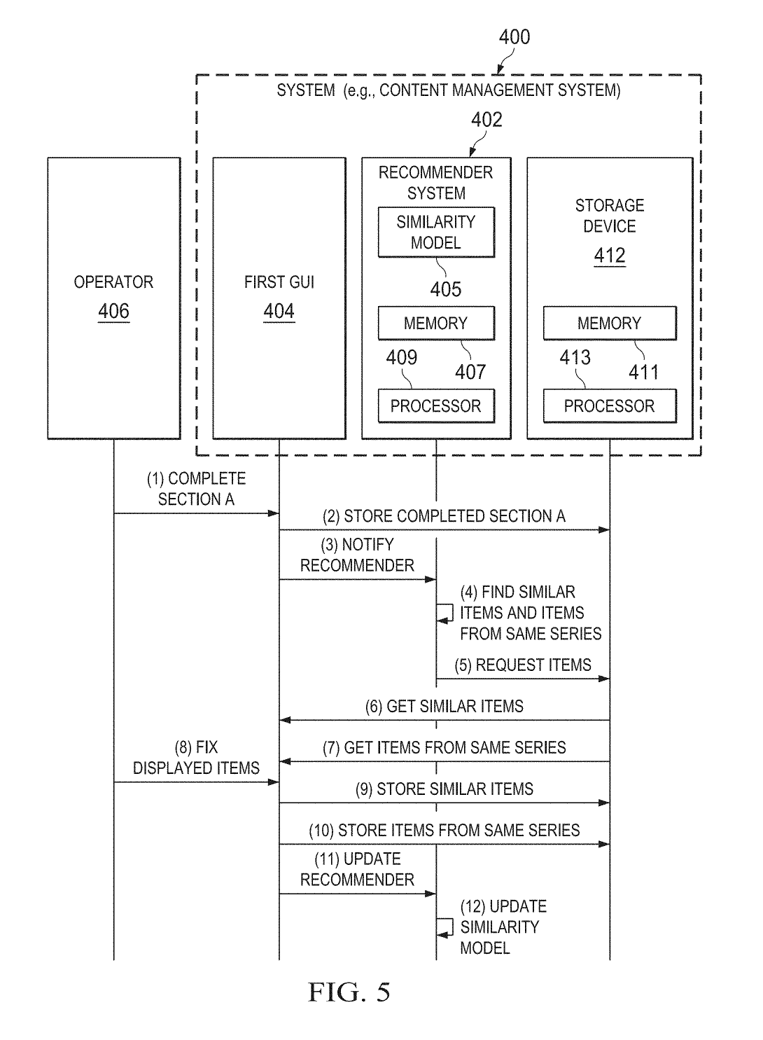

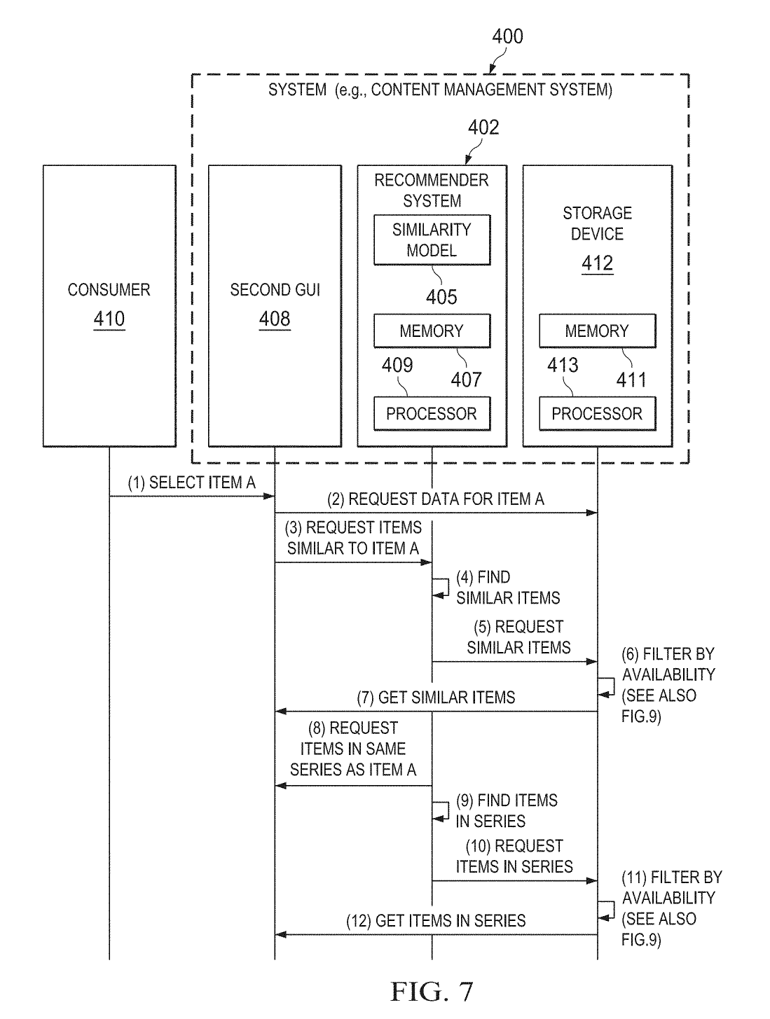

The system 400 (e.g., content management system 400) includes several components in addition to the recommender system 402 namely a first GUI 404 (which is an interface for a human operator 406), a second GUI 408 (which is an interface for a customer 410), and a storage unit 412 (see FIGS. 5 and 7). Referring to FIG. 4, there is illustrated a basic diagram of an exemplary first GUI 404 that is configured in accordance with an embodiment of the present disclosure. The exemplary first GUI 404 is built to have three sections shown as section A 414, section B 416, and section C 418. Section A 414 is known in the art and used by the operator 406 to enter metadata such as the title, title type, genres, cast etc. . . . about an item (e.g., movie) within a title field 420, title type field 422, genres field 424, cast field 426 etc. . . . . The metadata entered here will be used by the system 400 to populate section B 416 and section C 418. Section B 416 has three fields a similar titles field 428, a suggested similar titles field 430, and an other similar titles field 430. The suggested similar titles field 430 will be populated by the system 400 with suggested items Title M1, Title M2 . . . Title Mn. The suggested items Title M1, Title M2 . . . Title Mn. will be corrected and/or sorted (ranked) by the operator 406 (if necessary) as discussed in more detail below. While Section C 418 has three fields a titles in this series field 434, a suggested titles in this series field 436, and an other titles in this series field 438. The suggested titles in this series field 436 will be populated by the system 400 with suggested items Title S1, Title S2 . . . Title Sn. The suggested items Title S1, Title S2 . . . Title Sn will be corrected and/or sorted (ranked) by the operator 406 (if necessary) as discussed in more detail below. In one embodiment, both section B 416 and section C 418 will exist in the first GUI 404, however either section B 416 or section C 418 can exist and function without the other.

The likely user of the system 400 is a business unit who owns and manages a video library. Further, the user 406 who actually interacts with the system 400 and in particular the first GUI 404 is referred to herein as the operator 406. This operator 406 is one who is trained in the domain, whom is therefore considered an expert.

When the operator 406 enters details of a media item (movie/TV Series), the operator 406 will first perform the tasks as per usual in section A 416, adding all relevant metadata to the fields 420, 422, 424, 426 etc. . . . . At the bottom of the form, following all other regular entries, the operator 406 is shown a list of similar items Title M1, Title M2 . . . Title Mn in the suggested similar titles field 430 of Section B 418. The operator 406 can choose to sort the suggested movies Title M1, Title M2 . . . Title Mn by their perceived similarity, or to indicate that a suggestion is incorrect. In the exemplary first GUI 404, that means the operator 406 drags the suggested items {M1 . . . Mn} from their current position in the suggested similar titles field 430 to the similar titles field 428. The operator 406 can also use a freeform text field 432 shown as the other similar titles field 432 to enter their own suggestion of a similar movie, which will also be added to the similar titles field 428. The operator 406 can also sort (rank) the movies in the similar titles field 428 by perceived similarity (e.g., the rankings can be by virtue of the movies location in the similar titles field 428—the movie to the farthest left is the most relevant and the movie to the farthest right is the least relevant). The operator 406 can also directly mark any of the items in the suggested similar titles field 430 as “Not Similar”. This could be done with an option icon located on the icons {M1 . . . Mn}. Any item that isn't explicitly marked as Similar or Not Similar will be considered “unknowns”. This is not a preferred state, but could be allowed nonetheless. An alternative is that the front-end (or UI) could force the operator 406 to make an explicit choice if an item is similar or dissimilar. The UI could also default suggestions to True, and the operator 406 will only make explicit changes if an item is dissimilar, or unknown, and then sort the defaulted true items accordingly if required.

In section C 418, there is a field 434 labeled “Items in this Series”, where other items in this series will be entered. This is generally more applicable for movies that have sequels, rather than TV series. For example, if the operator 406 is keying in details for the movie “Lord of the Rings 2: The Two Towers”, they will be shown the “Lord of the Rings 1: Fellowship of the Rings” and “Lord of the Rings 3: The Return of the King” in the suggested title in this series field 436 by the recommender system 402. All of which are movies in this series. If the recommender system 402 or the algorithm run therein has for some reason not suggested either movie, the operator 406 can enter it manually into the items in this series field 434 by using the other titles in this series field 438. The operator 406 would use Section C 418 in order to place movies in the title in this series field 434 in a similar manner as described above with respect to Section B 416 when placing movies in the similar titles field 428.

The recommender system 402 will take all the input from the operator 406 into consideration in improving the algorithms (machine learning) it implements to evaluate similarity or same series for a media item. This will allow subsequent suggestions to the operator 406 to improve over time. Some metrics that could be used to evaluate algorithms for correctness includes: precision, measured as true positives over labelled data (#TP/(#TP+#FP)), true positives over total returned (#TP/(#TP+#FP+#unlabeled)), recall (#TP/(#TP+#FN)), Mean Average Precision (MAP), Mean Average Recall (MAR), Relative Mean Average Recall. Ranked measures could also be used such as Normalized Discounted Cumulative Gain (nDCG), MAP@k, MAR@k.

It is possible for an item that is part of the series to be misclassified as similar (or vice versa), especially since an item pair that is part of the same series must be similar to each other in the first place. The first GUI 404 could therefore enforce exclusivity by only allowing a title to be a member of either category. The first GUI 404 could also allow the operator 406 to easily move items between section B 416 and section C 418 and vice versa, for example with a drag-and-drop functionality. For this purpose, the first GUI 418 would place section B 416 and section C 418 on the same page, but an alternative could be built where after completing Section A 414, the operator 406 is taken to a different page that only has section B 416, and after completing section B 416, the operator 406 is taken to a different page (or “tab”) for section C 418.

It should be appreciated that implementing both section B 416 and section C 418 could be more useful, especially in the case of movies, however a provider per the present disclosure could opt to implement only one or the other. Likewise displaying section B 416 and section C 418 within the same page could also be more useful, but providers per the present disclosure could opt to display them for the operator 406 one after the other as discussed above.

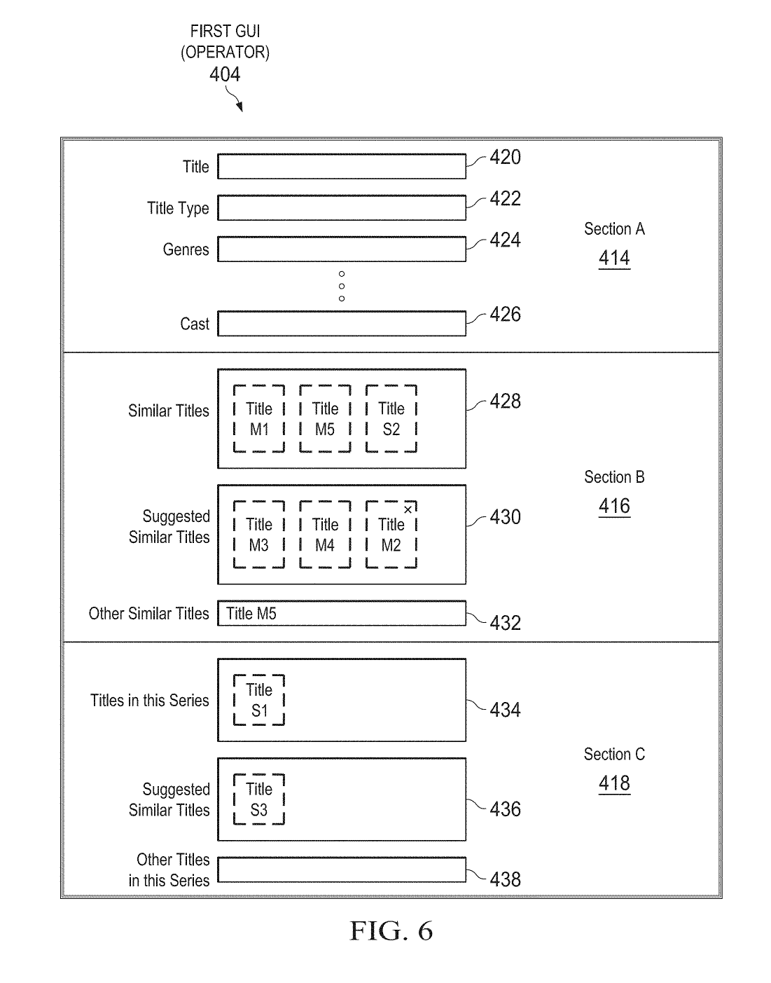

Referring to FIG. 5, there is a sequence diagram illustrated to show the interactions between the recommender system 402, the first GUI 404 (which is an interface for the operator 406) and the storage unit 412 in accordance with an embodiment of the present disclosure. In this example, the first GUI 404 utilizes section A 414, section B 416 and section C 418 where both section B 416 and section C 418 are displayed together (see FIG. 6). The main operator 406 interactions are to “Complete Section A” and “Fix displayed items in Sections B and C”. The details of each of these operations and more will be provided in the relevant parts of the step-by-step discussion below.

The operator 406 completes section A 414 of the first GUI 404 (see step 1). The operator 406 enters all the relevant metadata for the media item (e.g., movie) such as the title, title type, genres, cast etc. . . . within the title field 420, title type field 422, genres field 424, cast field 426 etc. . . . . The metadata entered here will be stored in the storage unit 412 (see step 2) and sent to the recommender system 402 (see step 3). The recommender system 402 upon receiving the metadata for the media item will implement an algorithm to find (calculate) similar items and items from same series (see step 4). The recommender system 402 may then send a fetch command to the storage unit 412 (see step 5) to have the calculated suggested similar items and suggested items from same series sent to and displayed in the first GUI 402 (front end) (see steps 6 and 7). The storage unit 412 can opt to only return items currently in the library if the business rules are set as such. In either case, the suggested similar items and the suggested similar items from the same series are shown to the operator 406 in the suggested similar titles field 430 of section B 416 and the suggested titles in this series field 436 of section C 418, respectively. The operator 406 will then move on to the next stage of their task which is to correct and sort the suggested similar items and the suggested similar items (see step 8). An example on how the operator 406 can correct and sort the suggested similar items and the suggested similar items is provided next with respect to FIG. 6.

FIG. 6 shows an example of corrections or updates that are performed by the operator 406 utilizing the first GUI 402 in accordance with an embodiment of the present disclosure. In this example, title M1 was suggested by the recommender system 402 and accepted as similar by the operator 406 who dragged title M1 from the suggested similar titles field 430 to the similar titles field 428. Title M5 was not recommended by the recommender system 402, but was evaluated to be similar by the operator 406 based on existing expertise. Hence, the operator 406 typed in title M5 in the other similar titles field 432 to have title M5 added to the similar titles field 428. Title M2 was suggested by the recommender system 402 as being similar, but the operator 406 decides that this is incorrect, and therefore marks title M2 as such in the suggested similar titles field 430. Title S2 was recommended by the recommender system 402 as an item in the series, but the operator 406 decided that title S2 was instead a similar item, and therefore moved title S2 from the suggested titles in this series field 436 to the appropriate location in the similar titles field 428. Titles M3 and M4 were suggested by the recommender system 402 as a title that is similar, but the operator 406 was unsure of this and therefore left titles M3 and M4 as is in the suggested similar titles field 430, where they can be labeled “unknown” by the recommender system 402. Title Si was accepted as an item in the same series so the operator 402 moved title S1 from the suggested titles in this series field 436 to the titles in this series field 434. Title S3 was suggested by the recommender system 402 as a title that is a title in this series, but the operator 406 was unsure of this and therefore left title S3 as is in the suggested titles in this series field 436, where title S3 can be labeled “unknown” by the recommender system 402.

The above example associated with FIG. 6 illustrates possible actions, where the operator 406 can optionally update the items shown in Section B 416 and/or Section C 418 in the first GUI 404. Updates could include moving items that were suggested as similar to the field for items from the same series or vice versa, or ranking the similar items by her perceived similarity (e.g., this ranking can be illustrated by the location of the items in the similar titles field 428 where title M1 ranked higher than title M5 which is ranked higher than Title S2) and the titles in this series field 434, or manually adding items not recommended by the recommender system 402. The act of ranking similar items and/or titles in this series is beneficial for the following reasons:

1. Model training: Similarity is not a binary, but a continuous variable; an item pair isn't just similar or not similar. There can be items that are more similar than others. For example, Man of Steel (2013) is more similar to Batman v. Superman: Dawn of Justice (2016) than it is to Superman (1978). The similarity model 405 can learn these differences over time as the level of similarity is indicated.

2. Lower mental load: Ranking is preferred over assigning a number to indicate similarity, as setwise (or group-wise) comparison has been shown to yield better results as it builds on the cognitive ability of labelers (operators) to provide better relative judgements than absolute ones (see Sarkar et al. “Setwise Comparison: Consistent, Scalable, Continuum Labels for Computer Vision” 2016—the contents of which are incorporated herein by reference for all purposes). Assigning numbers or the use of a Likert scale is a viable alternative, but is expected to cause low inter- and intra-rater reliability (see Sarkar et al). A possible way to solve this is to provide more training, so that the operators 406 are aware what each number means. In addition, it will require an explicit decision during input whereas ranking will require less decision making, and therefore decrease the mental load of the operator 406.

3. Display of the items to the users 410: Items that are more similar will be shown first. In addition, if there are more items in the curated list than there is space in the front end (second GUI 408), the most similar items could be shown first.

4. Updating existing library: If item M5 is added, and the operator 406 decides that it is similar to item M6, then item M6 will also be updated to include item M5. The ranking of item M6 against other similar items will allow the recommender system 402 to infer the ranking of M5 against other items similar to M6.

The ability for the operator 402 to add items that are similar (or in the same series) but not suggested by the recommender system 402 will likewise improve the list of similar items displayed to the user 410 in the second GUI 410, and will allow the recommender system 402 to learn better and faster.

Once, the operator 406 has interacted with the first GUI 404 to fix the displayed items in the similar titles field 428 and/or the titles in this series field 438 (see step 8), then the items in section B 416 and/or section C 418 of the first GUI 404 are sent to and stored within the storage unit 412 (see steps 9 and 10). Plus, the items in the section B 416 and/or section C 418 of the first GUI 404 are sent to the recommender system 402 (see step 11).

The recommender system 402 upon receiving the items in section B 416 and/or section C 418 of the first GUI 404 will use this information to update the similarity model 405 (e.g., algorithm(s)) (see step 12). In this way, the similarity model 405 (e.g., algorithm(s)) used to suggest items (e.g., movies) in section B 416 and/or section C 418 are expected to improve over time. One key to this improvement is the explicit labels collected when operators 406 mark suggested items as similar or dissimilar. In addition, the similarity model 405 (e.g., algorithm(s)) could optionally use the ordering of the items in the list of similar items as implicit input to measure how similar item pairs are, at least in comparison to one another.

Some general approaches that could be taken by the recommender system 402 to implement the similarity model 405 (e.g., algorithm(s)) include utilizing a TF-IDF process, a linear regression process, a logistic regression process, a SVM, artificial neural networks, Bayesian belief networks, random forests, or a combination of these. The principles of similarity learning, an area of machine learning particularly close to this can also be used by the recommender system 402. If the operator 406 decides to rank items by perceived similarity, then Discounted Cumulative Gain (DCG) or Normalized Discounted Cumulative Gain (nDCG) could be used as metric to measure correctness, and/or to compare different models for correctness. The recommender system 402 has a module that evaluates these algorithms in real time and selects the best similarity model 405 and corresponding parameters to tune the similarity model 405 if applicable. Alternatively, the recommender system 402 can implement only one similarity model 405 (e.g. linear regression) where the online-learning comprises of the model learning new and better parameters (e.g. regression/standardized coefficients) with each label collected from the operator 406.

The model(s) 405 used by the recommender system 402 for predicting similar items for section B 416 are not necessarily the same as the model(s) 405 used for predicting items from the same series for section C 418. For example, the model 405 that predicts the latter could incorporate other features, such as identifying the character's name from the movie, perhaps through the plot.

Part of this learning and relearning could include a module within the recommender system 402 that does feature selection, feature engineering or data preprocessing. For example stemming, removal of stop-words or removal of proper nouns could make a difference to the correctness of the model 405. The recommender system 402 could also allow for a data engineer to peek into the models 405 to manually tune them, or to take the set of features and labels to be reevaluated offline.

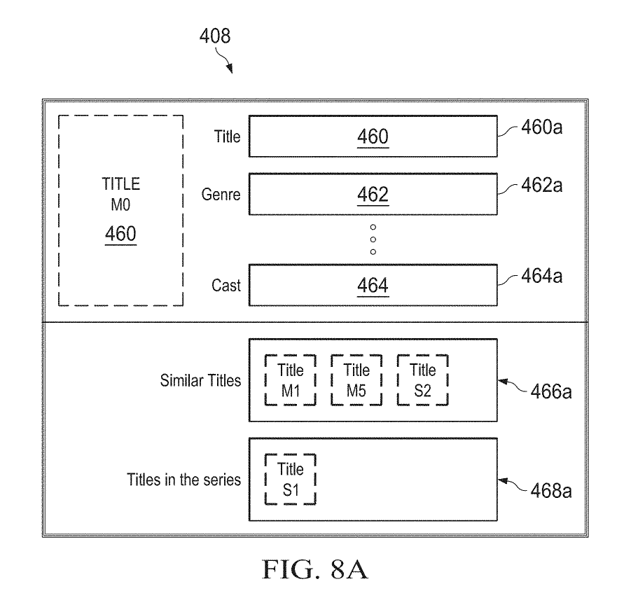

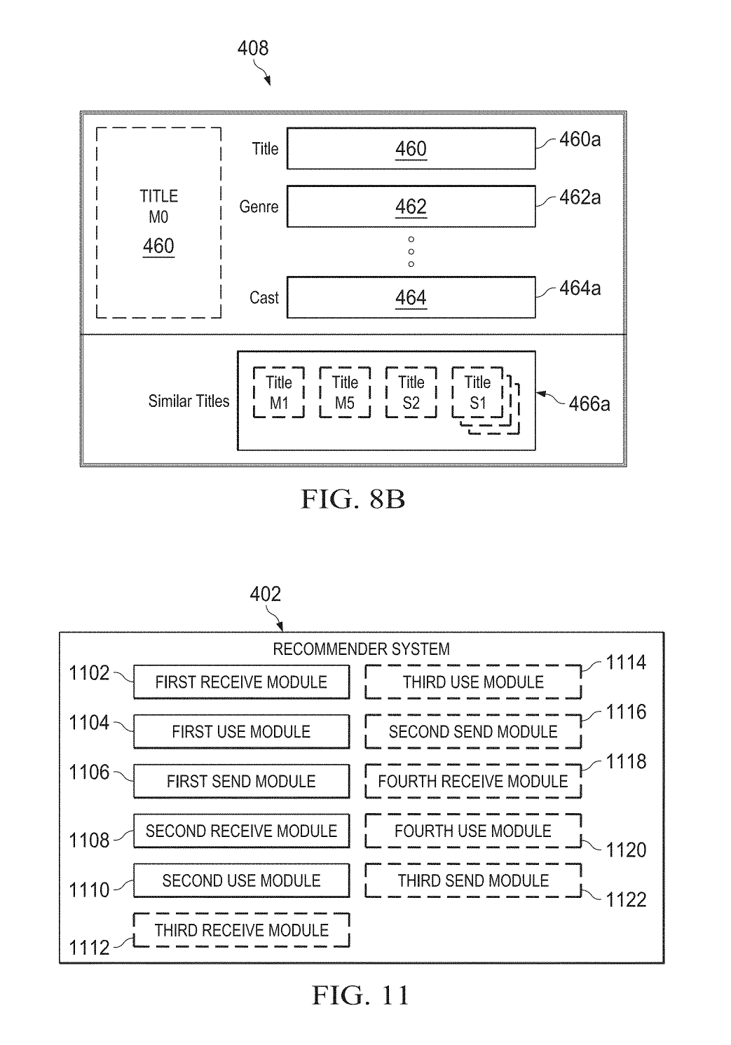

Referring to FIG. 7, there is a sequence diagram illustrated to show the interactions between the recommender system 402, the second GUI 408 (which is an interface for the consumer 410) and the storage unit 412 in accordance with an embodiment of the present disclosure. A step-by-step discussion below is provided to describe an exemplary way of how the recommender system 402 in response to a specific item 460 being entered in a specific item field 460a the second GUI 408 by the consumer 410 can populate a list of similar items field 466a with similar items (e.g., titles M1, M5 and S2) to the specific item 460 in the second GUI 408 and/or populate an items from the same series field 468a with similar items in this series (e.g., title S1) to the specific item 460 in the second GUI 408 for the consumer 410. FIG. 8A illustrates an exemplary second GUI 408 that can be used by the consumer 410 to input the specific item 460 (e.g., title M0), the genre 462, the cast 464 etc. . . . respectively in the title field 460a, the genre field 462a, the cast field 464a etc. . . . and then the recommender system 402 provides the consumer 410 with similar items (e.g., titles M1, M5 and S2) to the specific item 460 in the similar titles field 466a and/or items in this series (e.g., title S1) to the specific item 460 in the items from the same series field 468a. Alternatively, FIG. 8B illustrates an exemplary second GUI 408 that can be used by the consumer 410 to input the specific item 460 (e.g., title M0), the genre 462, the cast 464 etc. . . . respectively in the title field 460a, the genre field 462a, the cast field 464a etc. . . . and then the recommender system 402 provides the consumer 410 with similar items (e.g., titles M1, M5 and S2) and/or items in this series (e.g., title Si) to the specific item 460 in the similar titles field 466a.

Referring back to FIG. 7, the consumer 410 enters the metadata for a specific item 460 (e.g. movie—title M0) into the title field 460a, the genre field 462a, cast field 464a etc. . . . of the second GUI 408 (see step 1). A request for data related to the specific item 460 will be sent from the second GUI 408 to the storage unit 412 (see step 2). A request for items similar to the specific item 460 will be sent from the second GUI 408 to the recommender system 402 (see step 3). The recommender system 402 upon receiving the request for items similar to the specific item 460 implements an algorithm (similarity model 405) to find (calculate) similar items (e.g., titles M1, M5 and S2) to the specific item 460 (see step 4). The recommender system 402 sends a fetch command to the storage unit 412 (see step 5) to have the calculated similar items (e.g., titles M1, M5 and S2) sent to and displayed in the similar titles field 466a of the second GUI 408. If desired, the storage unit 412 can opt to only return items to the second GUI 408 which are currently available in the library (see step 6). For example, the storage unit 412 can perform a filtering operation to ensure that only items that are currently available in the library is provided to the consumer 410. This filtering could additionally consider only items that are available in the library and available to the consumer 410 based on restrictions in their licensing. Further, restrictions on what items are made available to the consumer 410 could be applied based on subscription levels, geographic locations, or parental controls among others. In this example, the calculated similar items (e.g., titles M1, M5 and S2) are shown to the consumer 410 in the similar titles field 462 (see step 7). The list of similar items (e.g., titles M1, M5 and S2) that is shown to the consumer 410 will therefore be selected from the list of curated and possibly sorted items by the operator 406 (see FIGS. 5-6). At this point, the consumer 410 can select one of the items (e.g., titles M1, M5 and S2) and have the storage unit 412 provide them the selected item (e.g., title M5).

In addition (or alternatively), the second GUI 408 can also send a request for items in the same series as the specific item 460 to the recommender system 402 (see step 8). The recommender system 402 upon receiving the request for items in the same series as the specific item 460 implements an algorithm (similarity model 405) to find (calculate) items in the same series (e.g., title Si) to the specific item 460 (see step 9). The recommender system 402 sends a fetch command to the storage unit 412 (see step 10) to have the calculated items in the same series (e.g., title S1) sent to and displayed in the titles in the same series field 464 of the second GUI 408. If desired, the storage unit 412 can opt to only return items which are currently available in the library (see step 11). For example, the storage unit 412 can perform a filtering operation to ensure that only items that are currently available in the library are provided to the consumer 410. This filtering could additionally consider only items that are available in the library and available to the consumer 410 based on restrictions in their licensing. Further, restrictions on what items are made available to the consumer 410 could be applied based on subscription levels, geographic locations, or parental controls among others. In this example, the calculated titles in the same series (e.g., title S1) are shown to the consumer 410 in the titles in the series field 466a, 468a (see step 12). The list of items in the same series (e.g., title S1) that is shown to the consumer 410 will therefore be selected from the list of curated and possibly sorted items by the operator 406 (see FIGS. 5-6). At this point, the consumer 410 can select one of the items (e.g., title S1) and have the storage unit 412 provide them the selected item (e.g., title S1).

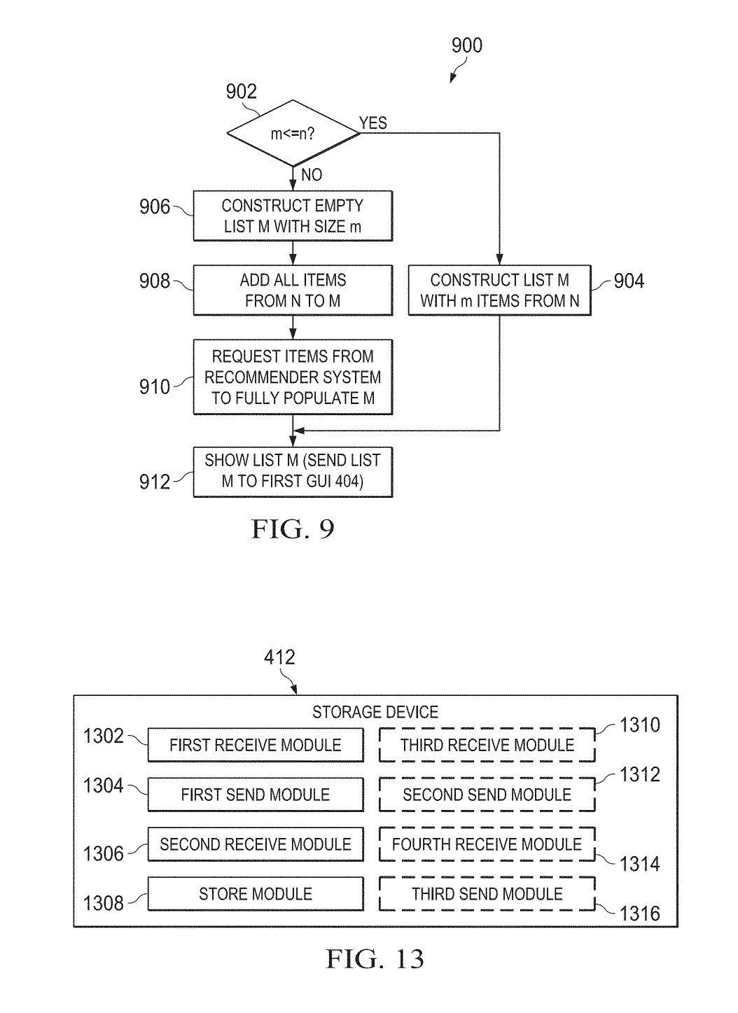

The above steps 7 and 12 where the storage unit 412 will “get similar items” could be deconstructed into a workflow of several sub-steps itself. This workflow is important as the basic problem that is solved by the present disclosure is how to generate a list of similar items and/or items from the same series for the consumer 410. The system 400 can therefore predetermine a minimum (and/or maximum) number of items in the list(s). However, there can be little guarantee that the number of curated items will always exist to meet the minimum number of items in the list(s). To address this issue, the storage unit 412 can implement an optional workflow to their “get similar items” steps 7 and 12. This optional workflow is discussed next with respect to FIG. 9.

Referring to FIG. 9, there is a flowchart of a method 900 implemented in the storage unit 412 to enhance the “get similar items” steps 7 and 12 of FIG. 7 in accordance with an embodiment of the present disclosure. Assume, the system 400 wants to construct a list of similar items M (or items in this series M) with a minimum number of m items. For all items (e.g., movies), the system 400 has a list of curated similar items N which has n items, where n>=0. The method 900 described below shows how the list of similar items M (or items in this series M) shown to the consumer 410 can be constructed depending on the difference between m and n. Beginning at step 902, the storage unit 412 determines whether m<=n. Based on a determination that m is <= to n, the storage unit 412 at step 904 constructs the list of similar items M (or items in this series M) with m items from the curated similar items N. Based on a determination that m is not <= to n, the storage unit 412 at step 906 constructs an empty list of similar items M (or items in this series M) with size m. At step 908, the storage unit 412 adds all items from the curated similar items N to the list of similar items M (or items in this series M). At step 910, the storage unit 412 requests items from the recommender system 402 in order to be able to fully populate the list of similar items M (or items in this series M). After steps 904 and 910, the storage unit 412 shows the populated list of similar items M (or items in this series M) to the consumer 410 (i.e., the storage unit 412 sends the populated the list of similar items M (or items in this series M) to the second GUI 408). To clarify, the storage unit 412 can fall back on the recommendations provided solely by the recommender system 402 if n=0. This will cause the storage unit 412 to regress to a solution that does not have any form of expert-curated or assisted list of similar items, at least for this one selected title. However, given sufficient labels from operators 406 (e.g. for other movies), this list of similar items M (or items in this series M) would still be an improvement over a system without such input.

### Alternative Implementation

Section A 414 of FIG. 4 does not necessarily need to be populated via the first GUI 404. Instead, section A 414 can be populated through software-driven ingestion. For example, it is possible for a media broadcaster to generate a file with section A 414 (or parts thereof) pre-filled. In which case the operator 406 could start by amending parts of section A 414 if and where needed, or immediately proceed to working on section B 416 and/or section C 418. In this alternative case, the workflow shown in FIG. 5 would still be intact, except that FIG. 5's step 1 “complete section A” is optional. It should be appreciated that in this case the operator 406 may only begin the workflow of FIG. 5 if the system 400 alerts them to the fact that their attention is required, either to complete section A 414 (if needed) and/or then complete section B 416 and/or section C 418 for certain title(s).

### Basic Functionalities—Configurations of Recommender System 402 and Storage Device 412

Referring to FIG. 10, there is a flowchart of a method 1000 implemented in the recommender system 402 in accordance with an embodiment of the present disclosure. At step 1002, the recommender system 402 receives, from the first GUI 404, metadata associated with a media item. At step 1004, the recommender system 402 uses the metadata of the media item and a similarity model 405 to find at least one of: (1) suggested similar items associated with the media item, and (2) suggested items from same series associated with the media item. At step 1006, the recommender system 402 sends, to the storage device 412, a first fetch command to have the at least one of: (1) the suggested similar items associated with the media item, and (2) the suggested items from same series associated with the media item sent to the first GUI 404 to be corrected by the operator 406. At step 1008, the recommender system 402 receives, from the first GUI 404, at least one of: (1) corrected (and possibly ranked) similar items associated with the media item, and (2) corrected (and possibly ranked) items from same series associated with the media item. At step 1010, the recommender system 402 uses the at least one of: (1) the corrected (and possibly ranked) similar items associated with the media item, and (2) the corrected (and possibly ranked) items from same series associated with the media item to update the similarity model 405 with respect to the media item. If desired, the recommender system 402 can also use labels provided by the operator 406 indicating at least one of: (1) the suggested similar items as being similar or dissimilar, and (2) the suggested items from same series as being similar or dissimilar to update the similarity model 405 with respect to the media item. At step 1012, the recommender system 402 receives, from the second GUI 408, a request by the consumer 410 for similar items related to the media item. At step 1014, the recommender system 402 uses the similarity model 405 to calculate similar items to the media item. At step 1016, the recommender system 402 sends, to the storage device 412, a second fetch command to have the calculated similar items sent to the second GUI 408. At step 1018, the recommender system 402 receives, from the second GUI 408, a request by the consumer 410 for items in a series related to the media item. At step 1020, the recommender system 402 uses the similarity model 405 to calculate items in the series related to the media item. At step 1022, the recommender system 402 sends, to the storage device 412, a third fetch command to have the calculated items in the series related to the media item sent to the second GUI 408. It should be appreciated that steps 1012, 1014, 1016 can be performed at same time as steps 1018, 1020, and 1022 (i.e., the consumer 410 can request in the same message both (1) calculated similar items, and (2) calculated items from same series for the media item).

Referring to FIG. 11, there is a block diagram illustrating structures of an exemplary recommender system 402 in accordance with an embodiment of the present disclosure. In one embodiment, the recommender system 402 comprises a first receive module 1102, a first use module 1104, a first send module 1106, a second receive module 1108, a second use module 1110, a third receive module 1112, a third use module 1114, a second send module 1116, a fourth receive module 1118, a fourth use module 1120, and a third send module 1122. The first receive module 1102 is configured to receive, from the first GUI 404, metadata associated with a media item. The first use module 1104 is configured to use the metadata of the media item and the similarity model 405 to find at least one of: (1) suggested similar items associated with the media item, and (2) suggested items from same series associated with the media item. The first send module 1106 is configured to send, to the storage device 412, a first fetch command to have the at least one of: (1) the suggested similar items associated with the media item, and (2) the suggested items from same series associated with the media item sent to the first GUI 404 to be corrected by the operator 406. The second receive module 1108 is configured to receive, from the first GUI 404, at least one of: (1) corrected (and possibly ranked) similar items associated with the media item, and (2) corrected (and possibly ranked) items from same series associated with the media item. The second use module 1110 is configured to use the at least one of: (1) the corrected (and possibly ranked) similar items associated with the media item, and (2) the corrected (and possibly ranked) items from same series associated with the media item to update the similarity model 405 with respect to the media item. If desired, the second use module 1110 can be configured to use labels provided by the operator 406 indicating at least one of: (1) the suggested similar items as being similar or dissimilar, and (2) the suggested items from same series as being similar or dissimilar to update the similarity model 405 with respect to the media item. The third receive module 1112 is configured to receive, from the second GUI 408, a request by the consumer 410 for similar items related to the media item. The third use module 1114 is configured to use the similarity model 405 to calculate similar items to the media item. The second send module 1116 is configured to send, to the storage device 412, a second fetch command to have the calculated similar items sent to the second GUI 408. The fourth receive module 1118 is configured to receive, from the second GUI 408, a request by the consumer 410 for items in a series related to the media item. The fourth use module 1120 is configured to use the similarity model 405 to calculate items in the series related to the media item. The third send module 1122 is configured to send, to the storage device 412, a third fetch command to have the calculated items in the series related to the media item sent to the second GUI 408. In addition, it should be noted that the recommender system 402 may also include other components, modules or structures which are well-known, but for clarity, only the components, modules or structures needed to describe the features of the present disclosure are described herein.

As those skilled in the art will appreciate, the above-described modules 1102, 1104, 1106, 1108, 1110, 1112, 1114, 1116, 1118, and 1120 may be implemented separately as suitable dedicated circuits. Further, the modules 1102, 1104, 1106, 1108, 1110, 1112, 1114, 1116, 1118, and 1120 can also be implemented using any number of dedicated circuits through functional combination or separation. In some embodiments, the modules 1102, 1104, 1106, 1108, 1110, 1112, 1114, 1116, 1118, and 1120 may be even combined in a single application specific integrated circuit (ASIC). As an alternative software-based implementation, the recommender system 402 may comprise a memory 407, and a processor 409 (including but not limited to a microprocessor, a microcontroller or a Digital Signal Processor (DSP), etc.) (see FIGS. 5 and 7). The memory 407 stores machine-readable program code executable by the processor 409 to cause the recommender system 402 to perform the steps of the above-described method 1000.

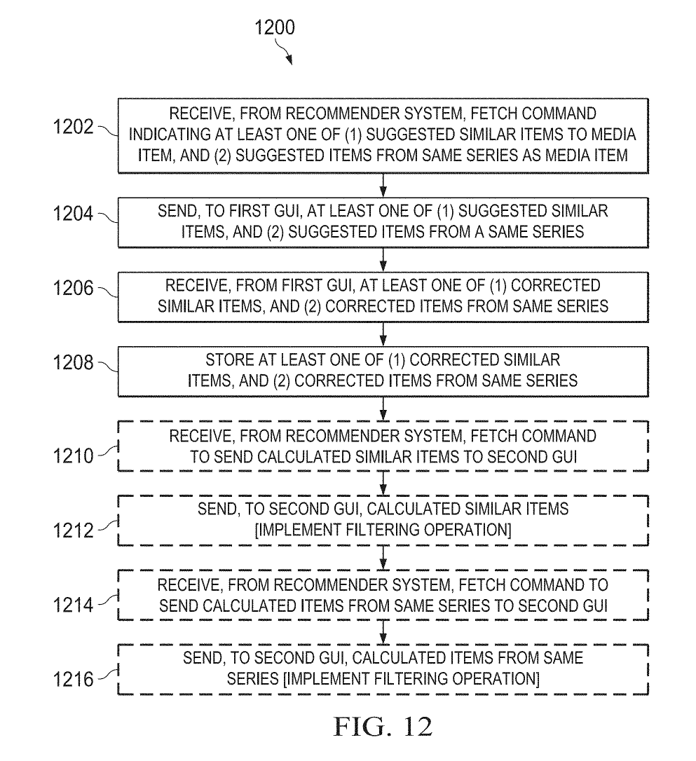

Referring to FIG. 12, there is a flowchart of a method 1200 implemented in the storage device 412 in accordance with an embodiment of the present disclosure. At step 1202, the storage device 412 receives, from the recommender system 402, a first fetch command indicating at least one of: (1) a suggested similar items associated with a media item, and (2) a suggested items from same series associated with the media item. At step 1204, the storage device 412 sends, to the first GUI 404, the at least one of: (1) the suggested similar items associated with the media item, and (2) the suggested items from same series associated with the media item to be corrected by an operator 406. At step 1206, the storage device 412 receives, from the first GUI 404, at least one of: (1) corrected (and possibly ranked) similar items associated with the media item, and (2) corrected (and possibly ranked) items from same series associated with the media item. At step 1208, the storage device 412 stores the at least one of: (1) the corrected (and possibly ranked) similar items associated with the media item, and (2) the corrected (and possibly ranked) items from same series associated with the media item. At step 1210, the storage device 412 receives, from the recommender system 402, a second fetch command to have calculated similar items associated with a request by the consumer 410 for similar items related to the media item sent to a second GUI 408. At step 1212, the storage device 412 sends, to the second GUI 408, the calculated similar items (see also FIG. 9 for more details on how the storage unit 412 can implement the sending step 1212). If desired, the storage device 412 implements a filtering operation where at least one of (1) only the calculated similar items which are available in a library are sent to the second GUI 408, and (2) only the calculated similar items which are permitted per one or more restrictions associated with the consumer 410 are sent to the second GUI 408. At step 1214, the storage device 412 receives, from the recommender system 402, a third fetch command to have calculated items in a series associated with a request by the consumer 410 for items in a series related to the media item sent to the second GUI 408. At step 1216, the storage device 412, sends, to the second GUI 408, the calculated items in a series (see also FIG. 9 for more details on how the storage unit 412 can implement the sending step 1218). If desired, the storage device 412 implements a filtering operation where at least one of (1) only the calculated items in the series which are available in a library are sent to the second GUI 408, and (2) only the calculated items in the series which are permitted per one or more restrictions associated with the consumer 410 are sent to the second GUI 408. It should be appreciated that steps 1210 and 1212 can be performed at same time as steps 1214 and 1216 (i.e., the consumer 410 can send one message requesting both (1) calculated similar items, and (2) calculated items from same series for the media item).

Referring to FIG. 13, there is a block diagram illustrating structures of an exemplary storage device 412 in accordance with an embodiment of the present disclosure. In one embodiment, the storage device 412 comprises a first receive module 1302, a first send module 1304, a second receive module 1306, a store module 1308, a third receive module 1310, a second send module 1312, a fourth receive module 1314, and a third send module 1316. The first receive module 1302 is configured to receive, from the recommender system 402, a first fetch command indicating at least one of: (1) a suggested similar items associated with a media item, and (2) a suggested items from same series associated with the media item. The first send module 1304 is configured to send, to the first GUI 404, the at least one of: (1) the suggested similar items associated with the media item, and (2) the suggested items from same series associated with the media item to be corrected by an operator 406. The second receive module 1306 is configured to receive, from the first GUI 404, at least one of: (1) corrected (and possibly ranked) similar items associated with the media item, and (2) corrected (and possibly ranked) items from same series associated with the media item. The store module 1308 is configured to store the at least one of: (1) the corrected (and possibly ranked) similar items associated with the media item, and (2) the corrected (and possibly ranked) items from same series associated with the media item. The third receive module 1310 is configured to receive, from the recommender system 402, a second fetch command to have calculated similar items associated with a request by the consumer 410 for similar items related to the media item sent to a second GUI 408. The second send module 1312 is configured to send, to the second GUI 408, the calculated similar items (see also FIG. 9 for more details on how the second send module 1312 can implement the sending operation). If desired, the second send module 1312 implements a filtering operation where at least one of (1) only the calculated similar items which are available in a library are sent to the second GUI 408, and (2) only the calculated similar items which are permitted per one or more restrictions associated with the consumer 410 are sent to the second GUI 408. The fourth receive module 1314 is configured to receive, from the recommender system 402, a third fetch command to have calculated items in a series associated with a request by the consumer 410 for items in a series related to the media item sent to the second GUI 408. The third send module 1316 is configured to send, to the second GUI 408, the calculated items in a series (see also FIG. 9 for more details on how the third send module 1316 can implement the sending operation). If desired, the third send module 1316 is configured to implement a filtering operation where at least one of (1) only the calculated items in the series which are available in a library are sent to the second GUI 408, and (2) only the calculated items in the series which are permitted per one or more restrictions associated with the consumer 410 are sent to the second GUI 408. In addition, it should be noted that the storage device 412 may also include other components, modules or structures which are well-known, but for clarity, only the components, modules or structures needed to describe the features of the present disclosure are described herein.

As those skilled in the art will appreciate, the above-described modules 1302, 1304, 1306, 1308, 1310, 1312, 1314, and 1316 may be implemented separately as suitable dedicated circuits. Further, the modules 1302, 1304, 1306, 1308, 1310, 1312, 1314, and 1316 can also be implemented using any number of dedicated circuits through functional combination or separation. In some embodiments, the modules 1302, 1304, 1306, 1308, 1310, 1312, 1314, and 1316 may be even combined in a single application specific integrated circuit (ASIC). As an alternative software-based implementation, the storage device 412 may comprise a memory 411, and a processor 413 (including but not limited to a microprocessor, a microcontroller or a Digital Signal Processor (DSP), etc.) (see FIGS. 5 and 7). The memory 411 stores machine-readable program code executable by the processor 413 to cause the storage device 412 to perform the steps of the above-described method 1200.

In view of the foregoing discussion, one skilled in the art should readily appreciate that the content management center 400 has at least the following features:

1. Self-learning or online-learning of item-item similarity and/or items (e.g., movies) from the same series where expert human judgment (i.e., operator 406) is used both as:
a. A final decision regarding what items to show to the consumer 410, and
b. Labels for a supervised learning algorithm implemented in the recommender system 402.

2. A system 400 that allows an operator 406 to:
a. Select similar items from a list of suggestions either visually (e.g., posters, movie art, DVD cover, etc) or textually (e.g., name and year released) and optionally rank them based on their perceived similarity by the operator 406.
b. Or, manually enter a search term to denote similar items (e.g., movies) not suggested by the recommender system 402.
c. Or, a combination of both the above (a) and (b).

3. The system 400 which allows the operator 406 to:
a. Select items from the same series based on suggestions either visually (e.g., posters, movie art, DVD cover, etc) or textually (e.g., name and year released) and optionally rank them based on their perceived similarity by the operator 406.
b. Or, manually enter a search tem to denote other items (e.g., movies) from the same series not suggested by the recommender system 402.
c. Or, a combination of both the above (a) and (b).

4. Using the output of the same recommender system 402 (1) to recommend similar items, or items from the same series or both, to the consumer 410 without curation, in the event that a curated list generally built in (2) or (3) is not available for a particular title, or the amount of curated items is lower than that which is preferred (or required) by the consumer-facing GUI 410 (e.g., see FIG. 9).

The content management center 400 has at least the following advantages:

1. Improves consumer 410 experience. A benefit of the system 400 is that it improves user experience of the consumers 410 by increasing the numbers of items (e.g., movies) presented to them that are actually similar, or similar enough to be plausible, while removing items that are obviously dissimilar from being presented to the consumers 410.

2. Improves customer experience. This approach allows for manual curation by operators 406 (e.g., experts 406), without adding too much mental load on the operator 406. Operators 406 generally need to manually key in details of media titles through the user interface of the system 400. During this process, the operator 406 will need to key in the title, genre, cast list or other metadata. The system 400 leverages the existing workflow for the operator 406 and adds another function namely to pick and sort similar titles from a list of suggested titles.

3. Increases list diversity. Adding a list of items (e.g., movies) from the same series will allow for more diversity in the list of similar items (e.g., movies). Diversity is a key metric in improving overall satisfaction with a recommender system (see Ekstrand et al. “User Perception of Differences in Recommender Algorithms” (2014)—the contents of this document are incorporated herein by reference for all purposes). For example, if the consumer 410 selects the movie “Lord of the Rings 1”, it would be better show them the sequels in the list of “Movies in this series” rather than in the list of similar movies. The latter can then be used to recommend other epic fantasy movies such as “The Chronicles Of Narnia” or “The Golden Compass”.

4. Allows online-learning. The input from the operator 406 can be used to improve the recommender system 402 to allow for the creation and evaluation of better algorithms, or ensemble of algorithms. In the inventor's previous research, they identified that a problem with traditional recommender systems, or information retrieval in general is that there are very few metrics for evaluation. It is trivial to evaluate precision (TP/(TP+FP)) since the user has access to the condition positive; that is all the items shown to her. It is harder to obtain the condition negatives, i.e., the media items that are not shown. This makes it difficult to identify False Negatives and True Negatives. The approach of the present disclosure allows for the evaluation of False Negatives, where false negatives are items (e.g., movies) that the algorithm(s) did not consider to similar, but the operator 406 considers them to be similar. This in turn allows the evaluation of algorithms by measuring recall (TP/TP+FN) on top of the existing precision of the recommender system 402.

### Example Implementation

Although the described solutions may be implemented in any appropriate type of system supporting any suitable communication standards and using any suitable components, particular embodiments of the described solutions may be implemented in a network that includes a server or a collection of servers, a network such as the Internet, local area network, or wide area network, and at least one client. The system 400, the recommender system 402, the storage device 410 etc. . . . can be implemented by a data processing system. The data processing system can include at least one processor that is coupled to a network interface via an interconnect. The memory can be implemented by a hard disk drive, flash memory, or read-only memory and stores computer-readable instructions. The at least one processor executes the computer-readable instructions and implements the functionality described above. The network interface enables the data processing system to communicate with other nodes (e.g., a server or a collection of servers, other clients, etc.) within the network. Alternative embodiments of the present invention may include additional components responsible for providing additional functionality, including any functionality described above and/or any functionality necessary to support the solution described above.

Those skilled in the art shall appreciate that the term “and/or” user herein is used to mean at least one of A, B, and C. Further, those skilled in the art will appreciate that the use of the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Of course, the present disclosure may be carried out in other specific ways than those herein set forth without departing from the scope and essential characteristics of the invention. One or more of the specific processes discussed above may be carried out in a cellular phone or other communications transceiver comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure have been illustrated in the accompanying Drawings and described in the foregoing Detailed Description, it should be understood that the invention is not limited to the disclosed embodiments, but instead is also capable of numerous rearrangements, modifications and substitutions without departing from the present disclosure that as has been set forth and defined within the following claims.

1. A system comprising:
a recommender system;
a first graphical user interface (GUI);
a storage device;
the first GUI is configured to transmit metadata of a media item to the recommender system;
the recommender system is configured to use the metadata of the media item and a similarity model to find at least one of: (1) suggested similar items associated with the media item, and (2) suggested items from same series associated with the media item;
the recommender system is further configured to send a first fetch command to the storage device to have the at least one of: (1) the suggested similar items associated with the media item, and (2) the suggested items from same series associated with the media item sent to the first GUI;
the first GUI is configured to display the at least one of: (1) the suggested similar items associated with the media item, and (2) the suggested items from same series associated with the media item and further configured to enable an operator to correct the at least one of: (1) the suggested similar items associated with the media item, and (2) the suggested items from same series associated with the media item to provide at least one of: (1) corrected similar items associated with the media item, and (2) corrected items from same series associated with the media item;
the first GUI is further configured to send the at least one of: (1) the corrected similar items associated with the media item, and (2) the corrected items from same series associated with the media item to the recommender system; and,
the recommender system is further configured to use the at least one of: (1) the corrected similar items associated with the media item, and (2) the corrected items from same series associated with the media item to update the similarity model with respect to the media item.

2. The system of claim 1, wherein the first GUI is further configured to enable the operator to rank the suggested similar items when providing the corrected similar items.

3. The system of claim 1, wherein:
the first GUI is further configured to enable the operator to label the at least one of: (1) the suggested similar items as being similar or dissimilar, and (2) the suggested items from same series as being similar or dissimilar; and
the recommender system is configured to use the labels of the at least one of: (1) the suggested similar items as being similar or dissimilar, and (2) the suggested items from same series as being similar or dissimilar to update the similarity model with respect to the media item.

4. The system of claim 1, wherein:
the recommender system is configured to use a machine learning technique to update the similarity model with respect to the media item, wherein the machine learning technique includes a Term Frequency-Inverse Document Frequency (TF-IDF) process, a linear regression process, a logistic regression process, a support vector machine (SVM), artificial neural networks, Bayesian belief networks, random forests, or a combination of these.

5. The system of claim 1, further comprising:
a second GUI configured to transmit a request by a consumer for similar items related to the media item to the recommender system;
the recommender system configured upon receipt of the request to use the similarity model to calculate similar items to the media item;
the recommender system further configured to send a second fetch command to the storage device to have the calculated similar items sent to the second GUI;
the storage device configured to send the calculated similar items to the second GUI; and,
the second GUI configured to display the calculated similar items for the consumer.

6. The system of claim 5, wherein:
the storage device is configured to implement a filtering operation where at least one of (1) only the calculated similar items which are available in a library are sent to the second GUI, and (2) only the calculated similar items which are permitted per one or more restrictions associated with the consumer are sent to the second GUI.

7. The system of claim 5, wherein:
the storage device is configured to implement the sending of the calculated similar items to the second GUI by constructing a list of calculated similar items M which has a minimum number of m items while there is a list of operator-curated similar items N which has n items where n>=0 by performing following operations:
determine whether m<=n;
based on a determination that m is <= to n, construct the list of calculated similar items M with m items from the operator-curated similar items N, and send the calculated similar items M to the second GUI;
based on a determination that m is not <= to n, perform following operations:
construct an empty list of similar items M with size m;
add all items from the operator-curated similar items N to the list of calculated similar items M;
request items from the recommender system in order to fully populate the list of calculated similar items M; and,
send the calculated similar items M to the second GUI.

8. The system of claim 1, further comprising:
a second GUI configured to transmit a request by a consumer for items in a series related to the media item to the recommender system;
the recommender system configured upon receipt of the request to use the similarity model to calculate items in the series related to the media item;
the recommender system further configured to send a third fetch command to the storage device to have the calculated items in the series related to the media item sent to the second GUI;
the storage device configured to send the calculated items in the series related to the media item to the second GUI; and,
the second GUI configured to display the calculated items in the series related to the media item for the consumer.

9. The system of claim 8, wherein:
the storage device is configured to implement a filtering operation where at least one of (1) only the calculated items in the series which are available in a library are sent to the second GUI, and (2) only the calculated items in the series which are permitted per one or more restrictions associated with the consumer are sent to the second GUI.

10. The system of claim 8, wherein:
the storage device is configured to implement the sending of the calculated items in the series to the second GUI by constructing a list of calculated items in the series M which has a minimum number of m items while there is a list of operator-curated items in the series N which has n items where n>=0 by performing following operations:
determine whether m<=n;
based on a determination that m is <= to n, construct the list of calculated items in the series M with m items from the operator-curated items in the series N, and send the calculated items in the series M to the second GUI;
based on a determination that m is not <= to n, perform following operations:
construct an empty list of items in the series M with size m;
add all items from the operator-curated items in the series N to the list of calculated items in the series M;
request items from the recommender system in order to fully populate the list of calculated items in the series M; and,
send the calculated items in the series M to the second GUI.

11. The system of claim 1, wherein:
the first GUI comprises a first section and at least one of a second section and a third section:
the first section having a title field, a title type field, a genres field, and a cast field within which the metadata of the media item is entered by the operator;
the second section having a suggested similar titles field which displays the suggested similar items, an other similar titles field which receives manual input regarding a similar item from the operator, and a similar titles field which displays the corrected similar items; and,
the third section having a suggested titles in this series field which displays the suggested items in the same series, an other titles in this series field which receives manual input regarding an item in the series from the operator, and a titles in this series field which displays the corrected items from the same series.

12. The system of claim 1, further comprises:
a second GUI including a title field in which a media item is entered by a consumer, and at least one of (1) a similar titles field which displays similar items to the media item, and (2) a titles in a series field which displays items in the series; or
a second GUI including a title field in which a media item is entered by a consumer, and a similar titles field which displays similar items to the media item and items in the series.

13. A recommender system comprising:
a processor; and,
a memory that stores processor-executable instructions, wherein the processor interfaces with the memory to execute the processor-executable instructions, whereby the recommender system is operable to:
receive, from a first graphical user interface, metadata associated with a media item;
use the metadata of the media item and a similarity model to find at least one of: (1) suggested similar items associated with the media item, and (2) suggested items from same series associated with the media item;
send, to a storage device, a first fetch command to have the at least one of: (1) the suggested similar items associated with the media item, and (2) the suggested items from same series associated with the media item sent to the first GUI to be corrected by an operator;
receive, from the first GUI, at least one of: (1) corrected similar items associated with the media item, and (2) corrected items from same series associated with the media item;
use the at least one of: (1) the corrected similar items associated with the media item, and (2) the corrected items from same series associated with the media item to update the similarity model with respect to the media item.

14. The recommender system of claim 13, wherein the second use operation further comprises:
use labels provided by the operator indicating at least one of: (1) the suggested similar items as being similar or dissimilar, and (2) the suggested items from same series as being similar or dissimilar to update the similarity model with respect to the media item.

15. The recommender system of claim 13, wherein the recommender system is further operable to:
update the similarity model with respect to the media item using a machine learning technique selected from a Term Frequency-Inverse Document Frequency (TF-IDF) process, a linear regression process, a logistic regression process, a support vector machine (SVM), artificial neural networks, Bayesian belief networks, random forests, or a combination of these.

16. The recommender system of claim 13, wherein the recommender system is further operable to:
receive, from a second GUI, a request by a consumer for similar items related to the media item;
use the similarity model to calculate similar items to the media item; and,
send, to the storage device, a second fetch command to have the calculated similar items sent to the second GUI.

17. The recommender system of claim 13, wherein the recommender system is further operable to:
receive, from the second GUI, a request by a consumer for items in a series related to the media item;
use the similarity model to calculate items in the series related to the media item; and,
send, to the storage device, a third fetch command to have the calculated items in the series related to the media item sent to the second GUI.

18. A method in a recommender system, the method comprising:
receiving, from a first graphical user interface, metadata associated with a media item;
using the metadata of the media item and a similarity model to find at least one of: (1) suggested similar items associated with the media item, and (2) suggested items from same series associated with the media item;
sending, to a storage device, a first fetch command to have the at least one of: (1) the suggested similar items associated with the media item, and (2) the suggested items from same series associated with the media item sent to the first GUI to be corrected by an operator;
receiving, from the first GUI, at least one of: (1) corrected similar items associated with the media item, and (2) corrected items from same series associated with the media item;
using the at least one of: (1) the corrected similar items associated with the media item, and (2) the corrected items from same series associated with the media item to update the similarity model with respect to the media item.

19. The method of claim 18, wherein the second using step further comprises:
using labels provided by the operator indicating at least one of: (1) the suggested similar items as being similar or dissimilar, and (2) the suggested items from same series as being similar or dissimilar to update the similarity model with respect to the media item.

20. The method of claim 18, wherein the second using step further comprises:
updating the similarity model with respect to the media item using a machine learning technique selected from a Term Frequency-Inverse Document Frequency (TF-IDF) process, a linear regression process, a logistic regression process, a support vector machine (SVM), artificial neural networks, Bayesian belief networks, random forests, or a combination of these.

21. The method of claim 18, further comprising:
receiving, from a second GUI, a request by a consumer for similar items related to the media item;
using the similarity model to calculate similar items to the media item; and,
sending, to the storage device, a second fetch command to have the calculated similar items sent to the second GUI.

22. The method of claim 18, further comprising:
receiving, from the second GUI, a request by a consumer for items in a series related to the media item;
using the similarity model to calculate items in the series related to the media item; and,
sending, to the storage device, a third fetch command to have the calculated items in the series related to the media item sent to the second GUI.

23. A storage device
a processor; and,
a memory that stores processor-executable instructions, wherein the processor interfaces with the memory to execute the processor-executable instructions, whereby the storage device is operable to:
receive, from a recommender system a first fetch command indicating at least one of: (1) a suggested similar items associated with a media item, and (2) a suggested items from same series associated with the media item
send, to a first graphical user interface (GUI), the at least one of: (1) the suggested similar items associated with the media item, and (2) the suggested items from same series associated with the media item to be corrected by an operator;
receive, from the first GUI, at least one of: (1) corrected similar items associated with the media item, and (2) corrected items from same series associated with the media item;
store the at least one of: (1) the corrected similar items associated with the media item, and (2) the corrected items from same series associated with the media item.

24. The storage device of claim 23, wherein the storage device is further operable to:
receive, from the recommender system, a second fetch command to have calculated similar items associated with a request by a consumer for similar items related to the media item sent to a second GUI; and,
send, to the second GUI, the calculated similar items.

25. The storage device of claim 24, wherein the storage device is further operable to implement the sending of the calculated similar items to the second GUI by implementing a filtering operation where at least one of (1) only the calculated similar items which are available in a library are sent to the second GUI, and (2) only the calculated similar items which are permitted per one or more restrictions associated with the consumer are sent to the second GUI.

26. The storage device of claim 24, wherein the storage device is further operable to implement the sending of the calculated similar items to the second GUI by constructing a list of calculated similar items M which has a minimum number of m items while there is a list of operator-curated similar items N which has n items where n>=0 by performing following operations:
determine whether m<=n;
based on a determination that m is <= to n, construct the list of calculated similar items M with m items from the operator-curated similar items N, and send the calculated similar items M to the second GUI;
based on a determination that m is not <= to n, perform following operations:
construct an empty list of similar items M with size m;
add all items from the operator-curated similar items N to the list of calculated similar items M;
request items from the recommender system in order to fully populate the list of calculated similar items M; and,
send the calculated similar items M to the second GUI.

27. The storage device of claim 23, wherein the storage device is further operable to:
receive, from the recommender system, a third fetch command to have calculated items in a series associated with a request by a consumer for items in a series related to the media item sent to the second GUI; and,
send, to the second GUI, the calculated items in a series.

28. The storage device of claim 27, wherein the storage device is further operable to implement the sending of the calculated items in a series to the second GUI by implementing a filtering operation where at least one of (1) only the calculated items in the series which are available in a library are sent to the second GUI, and (2) only the calculated items in the series which are permitted per one or more restrictions associated with the consumer are sent to the second GUI.

29. The storage device of claim 27, wherein the storage device is further operable to implement the sending of the calculated items in the series to the second GUI by constructing a list of calculated items in the series M which has a minimum number of m items while there is a list of operator-curated items in the series N which has n items where n>=0 by performing following operations:
determine whether m<=n;
based on a determination that m is <= to n, construct the list of calculated items in the series M with m items from the operator-curated items in the series N, and send the calculated items in the series M to the second GUI;
based on a determination that m is not <= to n, perform following operations:
construct an empty list of items in the series M with size m;
add all items from the operator-curated items in the series N to the list of calculated items in the series M;
request items from the recommender system in order to fully populate the list of calculated items in the series M; and,
send the calculated items in the series M to the second GUI.

30. A method in a storage device, the method comprising:
receiving, from a recommender system a first fetch command indicating at least one of: (1) a suggested similar items associated with a media item, and (2) a suggested items from same series associated with the media item
sending, to a first graphical user interface (GUI), the at least one of: (1) the suggested similar items associated with the media item, and (2) the suggested items from same series associated with the media item to be corrected by an operator;
receiving, from the first GUI, at least one of: (1) corrected similar items associated with the media item, and (2) corrected items from same series associated with the media item;
storing the at least one of: (1) the corrected similar items associated with the media item, and (2) the corrected items from same series associated with the media item.

31. The method of claim 30, further comprising:
receiving, from the recommender system, a second fetch command to have calculated similar items associated with a request by a consumer for similar items related to the media item sent to a second GUI; and,
sending, to the second GUI, the calculated similar items.

32. The method of claim 31, wherein the second sending step further comprises:
implement a filtering operation where at least one of (1) only the calculated similar items which are available in a library are sent to the second GUI, and (2) only the calculated similar items which are permitted per one or more restrictions associated with the consumer are sent to the second GUI.

33. The method of claim 31, wherein the second sending step further comprises constructing a list of calculated similar items M which has a minimum number of m items while there is a list of operator-curated similar items N which has n items where n>=0 by performing following steps:
determining whether m<=n;
based on a determination that m is <= to n, constructing the list of calculated similar items M with m items from the operator-curated similar items N, and sending the calculated similar items M to the second GUI;
based on a determination that m is not <= to n, perform following steps:
constructing an empty list of similar items M with size m;
adding all items from the operator-curated similar items N to the list of calculated similar items M;
requesting items from the recommender system in order to fully populate the list of calculated similar items M; and,
sending the calculated similar items M to the second GUI.

34. The method of claim 30, further comprising:
receiving, from the recommender system, a third fetch command to have calculated items in a series associated with a request by a consumer for items in a series related to the media item sent to the second GUI; and,
sending, to the second GUI, the calculated items in a series.

35. The method of claim 34, wherein the second sending step further comprises:
implementing a filtering operation where at least one of (1) only the calculated items in the series which are available in a library are sent to the second GUI, and (2) only the calculated items in the series which are permitted per one or more restrictions associated with the consumer are sent to the second GUI.

36. The method of claim 34, wherein the second sending step further comprises constructing a list of calculated items in the series M which has a minimum number of m items while there is a list of operator-curated items in the series N which has n items where n>=0 by performing following steps:
determining whether m<=n;
based on a determination that m is <= to n, constructing the list of calculated items in the series M with m items from the operator-curated items in the series N, and sending the calculated items in the series M to the second GUI;
based on a determination that m is not <= to n, perform following steps:
constructing an empty list of items in the series M with size m;
adding all items from the operator-curated items in the series N to the list of calculated items in the series M;
requesting items from the recommender system in order to fully populate the list of calculated items in the series M; and,
sending the calculated items in the series M to the second GUI.
